(19) United States
(12) Patent Application Publication
(10) Pub. No.: US 2004/0184432 A1
(43) Pub. Date: Sep. 23, 2004

(54) Method for controlling streaming services

(76) Inventors: Ralitsa Gateva, (US); Miikka Poikselka, Espoo (FI)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/440,302

(22) Filed: May 19, 2003

(30) Foreign Application Priority Data
Mar. 19, 2003 (EP) 03006092.5

(51) Int. Cl. H04J 3/24

(52) U.S. Cl. 370/349

(57) ABSTRACT

The present invention concerns a method for controlling streaming services between a terminal (UE) and a streaming server (SS) via a communication network, wherein the communication network comprises at least one application server (AS) and a controlling entity (PCF, CSCF), the method comprising the steps of: requesting (1-3) a streaming session by said terminal at said application server, negotiating (4-8) streaming session details between the application server (AS) and the streaming server (SS), informing (9-10) the controlling entity (PCF) of the result of negotiating, and creating (11), at said controlling entity (PCF), authorization information for the requested streaming session, and supplying (14) access nodes (GGSN) of the communication network with the authorization information.

### FIELD OF THE INVENTION

The present invention relates to a method for controlling streaming services between a terminal and a streaming server via a communication network

### BACKGROUND OF THE INVENTION

During the recent years, communication networks have experienced considerable progress. The usage of mobile communication services as well as the usage of the Internet have widely spread. Most recent developments aim to combine the mobile communication networks and the Internet in that a mobile user may also access the data sources available via the Internet from his terminal.

Among such data sources, multimedia data are becoming more and more popular, i.e. audio and/or video data can also be accessed in the Internet. Also, it is sometimes desirable to download such multimedia data for later use and/or repeated use. Such a download can be offered for free, or it can be charged for. Downloading such multimedia data is also referred to as streaming.

For streaming purposes, special protocols have been developed. One example for these is the RTSP (real time streaming protocol), and the subsequent description of the present invention will focus on this example, while it is not intended to restrict the invention to this particular protocol. Other protocols are equally well applicable to the present invention such as the RTP (real time protocol), or the like such as HTTP (hypertext transfer protocol), UDP (user datagram protocol), TCP (transmission control protocol).

Likewise, the present invention will be described with a focus on the UMTS (universal mobile telecommunication system) network architecture as proposed by the 3^{rd} Generation Partnership project 3GPP, as this can currently be considered to be one of the most “sophisticated” communication network architectures enabling the usage of various services to the network's subscribers. However, the UMTS network architecture is also chosen as a mere example only and the present invention may be equally well applicable to any other communication network architecture as long as such an architecture exhibits the same or similar basic functional behavior/possibilities as the UMTS network.

Also for streaming purposes, data are transmitted in units of packets and streaming between two end points, i.e. a source and destination of streaming is governed by e.g. the PSS-E, i.e. the end-to-end packet-switched streaming service. In current specifications, however, such streaming traffic is transparent for the UMTS network. This means that the UMTS network is not aware of streaming traffic and thus, because the RTSP traffic is transparent for the UMTS network, the network operator cannot perform any control over the usage of a PDP context carrying this RTSP traffic.

Document WO 01/69950 A1 discloses already a method and system for activating a packet subscriber context for packet data. In detail, this document discloses a method for activating a context in a first network so as to transfer a call and/or transaction via said first network and a second network, said method comprising the steps of:

setting up a connection according to an application protocol using a signaling or default context within said first network; determining a capability information based on a message of said application protocol transmitted from said second network to said first network; and activating said context based on said received capability information. In terms of application protocols, H.323, H.248 and SIP are expressly mentioned. However, also with this solution, transmitted application protocol messages remain transparent for the UMTS network (core network) and are thus beyond control.

Nevertheless, streaming traffic (as an example of an application) consumes network resources which will result in other services being disturbed, e.g. only a lower QoS is possible, or even blocked. Also, the network operator can not charge for the usage of the resources used by the streaming traffic, which is undesirable from a network operator's point of view.

### SUMMARY OF THE INVENTION

Consequently, it is an object of the present invention to provide an improved method for controlling streaming services between a terminal and a streaming server via a communication network.

According to the present invention, the above object is for example achieved by a method for controlling streaming services between a terminal and a streaming server via a communication network, wherein the communication network comprises at least one application server and a controlling entity, the method comprising the steps of: requesting a streaming session by said terminal at said application server, negotiating streaming session details between the application server and the streaming server, informing the controlling entity of the result of negotiating, and creating, at said controlling entity, authorization information for the requested streaming session, and supplying access nodes of the communication network with the authorization information.

According to favorable further developments

the method further comprises a step of applying said authorization information at the gateway nodes for the requested streaming session;

said requesting comprises including the source and destination addresses and port numbers in the request;

said requesting further comprises including quality of service QoS information in the request.

By virtue of the present invention, basically the following advantages are be achieved:

with the proposed combination of IP Multimedia Subsystem IMS and end-to-end packet switched streaming service (PSS-E), an IMS operator can provide streaming services to a mobile user;

an additional advantage of this option is that an IMS operator can authorize (i.e. control) streaming signaling and streaming media flows (in addition to the already defined control of SIP session signaling and media flows signaling);

the method offers an opportunity to network operators to increase revenues by claiming their share of the revenues created by streaming media downloads through their networks, i.e. the usage of network resources is enabled to be paid for.

Furthermore, the above object is achieved by a system as defined in the appended system claims.

Still further, the above object is achieved by a terminal, an application server, a streaming server, and a controlling entity, respectively, as defined in the respective appended independent claims.

According to the proposed solution, streaming traffic such as RTSP traffic is controlled and authorized by a controlling entity such as a PCF of the communication network. The solution comprises e.g. including the source and destination addresses such as IP (Internet Protocol) addresses and port numbers as well as QoS information for the RTSP session in for example a SDP (Session Description Protocol) message that is sent in conjunction with for example a SIP INVITE message (SIP=Session Initiation Protocol) to an application server, the application server negotiating with a streaming server for session details, the application server responding to the INVITE message with a message that contains the necessary information for setting up for example a PDP context (PDP=Packet Data Protocol) and authorizing the RTSP session by PCF, and the PCF creating an authorization token to be used by a GGSN (Gateway GPRS Support Node, GPRS=General Packet Radio Service) in authorizing the PDP context for the RTSP session.

The present invention enables that in future there is a possibility to standardize the combination of the IP Multimedia Subsystem (IMS) and transparent end-to-end packet switched streaming service (PSS-E), as in this way the IMS operator can provide streaming services to the mobile user. Additionally, the advantage of this invention is that the operator has the opportunity to control and authorize the streaming signaling and the streaming media flows in addition to the already defined control of the SIP session signaling and media flows. In this manner, the operator will prevent misuse of service and negative service experience for the user. Furthermore, the control of the streaming signaling will give the operator the possibility to have separate charging schemes for the streaming signaling.

### BRIEF DESCRIPTION OF THE DRAWINGS

In the following, the present invention will be described in greater detail with reference to the accompanying drawings, in which

FIG. 1 shows a schematic overview over entities involved in carrying out the present invention; and

FIG. 2 shows a detailed signaling diagram with individual signaling messages exchanged between the entities.

### DETAILED DESCRIPTION OF THE EMBODIMENTS

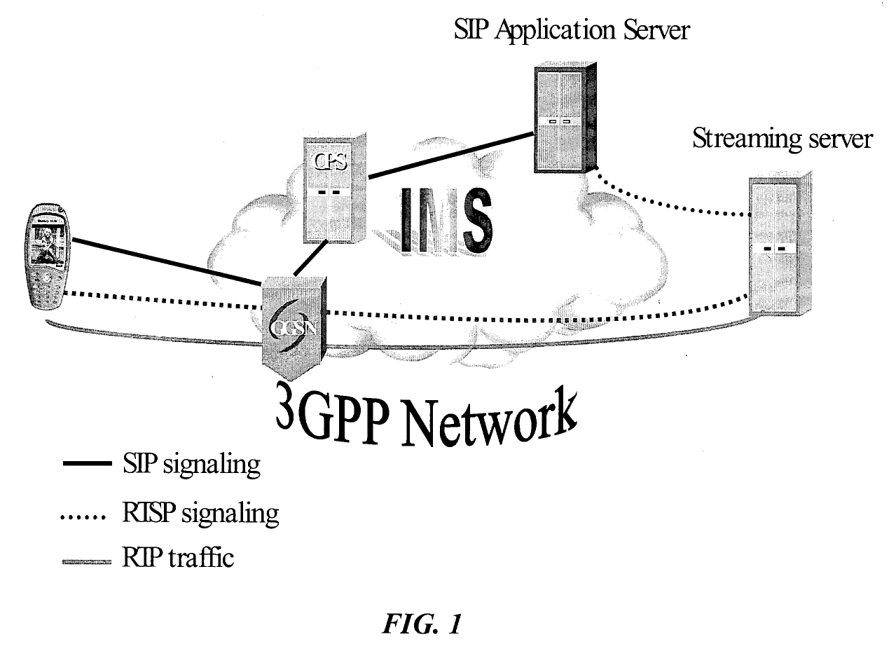

FIG. 1 shows a schematic overview over entities involved in carrying out the present invention.

A user terminal such as a mobile terminal for example is adapted to communicate with the communication network. The invention is, however, not limited to mobile terminals but other terminals capable of accessing the communication network may also be used. In this connection, it is to be noted that the access of the terminal to the network is established via an access network (not shown) which—in case of a UMTS communication network—comprises a plurality of access nodes known as Node_B, which in turn are under control of a radio network controller RNC. The access network of UMTS is also referred to as UTRAN (universal terrestrial radio access network). It is also to be noted that a radio access network is chosen as an example only and not limiting the invention, since also a non-radio access network is applicable. As shown in FIG. 1, the terminal communicates via an intermediate of a Gateway GPRS Support Node GGSN. The GGSN performs a gateway functionality from the access network via a SGSN (both not shown) to other networks or subnetworks, as the sequence from the UE onwards is known to be UE-RAN-SGSN-GGSN . . . .

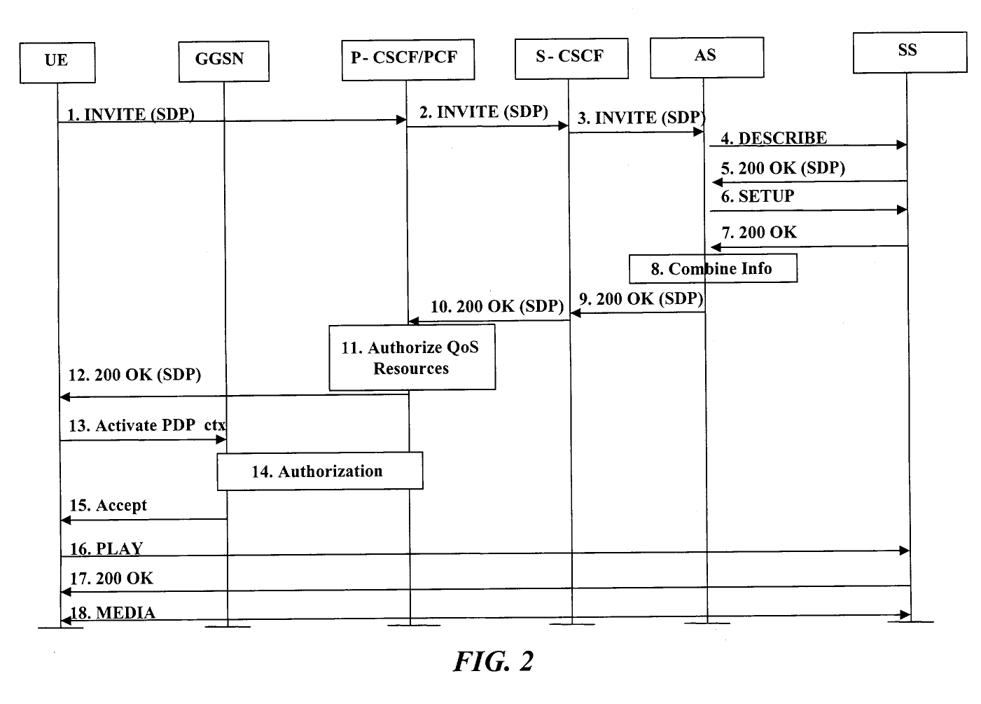

One of these subnetworks is for example the IMS network (IP Multimedia Subsystem). The IMS is represented in FIG. 1 by a entity denoted with the abbreviation “CPS” and representing a server (e.g. SIP server) adapted for processing connections. Such a server, though represented as a single block entity only, comprises all CSCF's and this entity is in cooperation with a (distinct) SIP application server. As mentioned, the server for connection processing combines and/or represents the functionalities of a P-CSCF/PCF and a S-CSCF shown as separate entities in FIG. 2 later on. (P-CSCF=Proxy-Call State Control Function, S-CSCF=Serving Call State Control Function, PCF=Policy Control Function).

The GGSN may also perform a gateway functionality towards the PSTN (Public Switched Telephone Network), the Internet or another data network, in particular a multimedia IP network.

Note that the SIP application server and the streaming server may be part of the same multimedia network or may belong to different networks. Also, the SIP application server has only been chosen as an example and the present invention may equally be applicable in case of e.g. WAP (Wireless Application Protocol) application servers or any other application servers.

Different types of signaling and/or traffic between the entities illustrated in FIG. 1 are denoted with differently labeled interconnections.

### BASIC EXAMPLE

The streaming traffic such as RTSP traffic can be treated similarly to the IMS signaling traffic. This means that for the RTSP traffic, a PDP context can be dedicated.

On one hand, in terms of a dedicated PDP context, it is possible to use the same PDP context as for IMS signaling traffic. In this case the signaling indication from the UE will be also reused.

It is also possible to allocate a separate PDP context only for the streaming signaling. In that case, a separate signaling indication from the UE should be generated. The benefit of this can be that the signaling for streaming can be charged differently than the signaling for the IMS traffic and the QoS for the PDP context, which carries the streaming (RTSP) traffic, can be different from the one for IMS traffic and for the media traffic.

In both cases, it is possible for the network operator to filter the RTSP flows, which can be performed by and/or implemented in the GGSN. To this end, static filters in the GGSN will be set up based on the information for the addresses (e.g. IP addresses) of the streaming servers.

### Embodiment 1

The streaming traffic such a RTSP or RTP traffic can be also authorized by e.g. the PCF as a control entity of the communication network. In this case, a scenario for combination of the IP Multimedia Subsystem (IMS) and transparent end-to-end packet switched streaming service (PSS-E) is applied. That is, it is possible to perform authorization of the source and destination of the RTSP traffic based on the SIP/SDP information at the IMS layer. This can be done if the destination and source IP addresses of the RTSP traffic are listed in the SDP. This indication is then a new extension to the SDP. Additionally, for precise control of the RTSP traffic, the destination and source port numbers should be available in the SDP.

Furthermore, the QoS of the RTSP can be authorized if there is QoS information for the streaming signaling in the SDP. In that case, the UE shall include the authorization token from the SIP session in the PDP context activation request, which will be used for the RTSP traffic. When the GGSN receives the PDP context request, it will perform the authorization request, as specified for the IMS media traffic carried by a PDP context. Alternatively, a specific QoS limit of the RTSP traffic can be settled in the GGSN.

In connection with the present invention, basic IM session (IP Multimedia) establishment mechanisms are applied to send a request for streaming e.g. in form of an SIP INVITE message to an application server (e.g. SIP application server). The INVITE message contains enough information about media content (e.g. file name) and a streaming server (storage location of media content, e.g. server address, using direct or indirect addressing schemes). The application server is responsible for requesting a description of the content (e.g. in terms of required QoS) and delivering information about a transport mechanism of the streamed media to the terminal UE. The terminal UE uses the received information to establish a normal streaming session as has been specified in connection with PSS-E. Thus, streaming RTSP messages are not sent via the IMS network part but they are sent through the transport network part.

Stated in other words, when such basic IMS session establishment mechanisms are applied to send an INVITE to an application server, the INVITE message contains enough information about media content and a streaming server (for example: file://temp/morning_news.smil, or http://mediaportal/morning_news.sdp, or rtsp://mediaportal/morning_news). The content may be indicated as plain text as in the above examples or in any coded form.

The application server is responsible for requesting a description of the content and delivering information about a transport mechanism of the streamed media (e.g. available/required coding and/or decoding equipment (“codecs”), audio and/or video, IP address, port numbers, bandwidth, etc.) to the UE. The UE uses the received information to establish normal streaming session as has been specified in PSS-E [26.233] [26.234].

RTSP methods (method meaning here signaling messages and commands) (such as DESCRIBE, SETUP, PLAY) are not sent via the IMS. In this embodiment, the RTSP traffic as such is also transparent for the UMTS network as it is in connection with PSS-E. However, in order to have adequate information for QoS authorization in this embodiment, it is required that an application server sends DESCRIBE (RTSP) (or HTTP_GET in HTTP) and SETUP messages. This is needed for obtaining port numbers and IP address which are used in QoS authorization.

As mentioned above, it is possible that the SIP application server and the streaming server are in the same network or in a different network. In addition, it is possible that more than one application servers are involved.

Session Establishment (FIG. 2):

Details of the method according to the present invention are explained with reference to FIG. 2. In horizontal direction, the network entities are shown with respective signaling messages exchanged there between. The vertical direction and numbers of signaling represents the sequence in time.

The depicted signaling is subsequently explained in greater detail:

Step 1: A UE sends a SIP INVITE to a SIP application server. Within the SDP, the UE informs what kind of media types it is willing to receive and its transport parameters. The INVITE message contains enough information about a media content and a streaming server.

Step 2: The P-CSCF/PCF receives the INVITE and extracts the necessary information for authorization purposes. The P-CSCF/PCF forwards the INVITE to the S-CSCF.

Step 3: The S-CSCF performs the service control and forwards the INVITE to the application server AS.

Step 4: Upon receiving the INVITE massage, the SIP application server uses the information from the INVITE message to communicate with the streaming server SS. This application server AS can use either a RTSP Describe message or HTTP Get message to request a description of the streaming session (dependent on the protocol used for streaming)from the streaming server SS. Here the RTSP DESCRIBE is shown.

Step 5: The streaming server SS responds to the RTSP Describe/HTTP Get command with a description of a streaming session that includes a SDP part with a codec information and other information about the session.

Step 6: The SIP application (running at the application server AS) uses information from the INVITE (SDP) and the received information from the streaming server SS to establish a corresponding RTSP SETUP message which contains the UE's transport parameters. This SETUP message is sent to the streaming server SS.

Step 7: The streaming server responds with SIP message “200 OK” which contains the port numbers from the streamed media.

Step 8: After receiving the SETUP response, the application server AS combines the session information from the Streaming Server SS and the UE, and forms the SIP “200 OK” message (of step 9.) for the SIP INVITE request coming from the UE. This “200 OK” response contains common SDP descriptions from both the Streaming Server SS and the UE.

Step 9: as mentioned before, the SIP application server sends “200 OK” towards the UE. This messages contains all necessary transport parameters for setting up an appropriate PDP context and the necessary information for the P-CSCF/PCF to perform authorization.

Step 10: The S-CSCF forwards the “200 OK” to the P-CSCF/PCF

Step 11: The P-CSCF/PCF receives the “200 OK” and extracts the necessary information for the authorization purposes and the PCF generates an authorization token.

Step 12: The P-CSCF/PCF sends the “200 OK” to the UE.

Step 13: The UE activates a PDP context (or modifies an existing one).

Step 14: The GGSN will use the authorization token for obtaining the QoS authorization of the PDP context from the P-CSCF/PCF.

Step 15: The GGSN accepts the PDP context activation.

Step 16: Upon receiving the response to INVITE, the UE proceeds with its RTSP signaling directly to the RTSP server i.e. it performs RTSP PLAY.

Step 17: The streaming server acknowledges the PLAY with 200 OK.

Step 18: The media starts flowing between the UE and the streaming server.

Session Termination (not Shown):

Step 1′: At the end of the session, RTSP TEARDOWN is executed.

Step 2′: Upon RTSP session teardown, the UE proceeds with sending a SIP BYE message to the SIP application server. Upon receiving the BYE message the P-CSCF(PCF) removes the authorization for resources.

Step 3′: The SIP application server sends a SIP “200 OK” to acknowledge the BYE message.

Even though herein before the present invention has been described with reference to the method aspects, it is evident that the present invention likewise concerns a corresponding system. That is, the present invention concerns a system for controlling streaming services between a terminal UE and a streaming server SS via a communication network, the system comprising a terminal UE, a streaming server SS, and a communication network, wherein the communication network comprises at least one application server AS and a controlling entity PCF, CSCF, the system being configured such that said terminal transmits a request 1-3 for a streaming session to said application server, the application server AS and the streaming server SS negotiate 4-8 streaming session details, said application server AS transmits information 9-10 of the result of negotiating to the controlling entity PCF, and said controlling entity PCF creates 11 authorization information for the requested streaming session, and supplies 14 access nodes GGSN of the communication network with the authorization information. The system is further configured such that said authorization information is applied 15 at the gateway nodes GGSN for the requested streaming session; and said request comprises the source and destination addresses and port numbers. Furthermore, said request further includes quality of service QoS information.

This system with its entities and its configuration is already described in connection with the description of FIG. 2 in detail, so that a repetition thereof is considered to be dispensable.

Nevertheless, when considering an internal structure of entities shown in FIG. 2, it is to be noted that though not shown in the drawings, from the foregoing description it is clear that:

in terms of a terminal such as a user equipment, a terminal comprises transmission means for transmitting a request, 1., for a streaming session to an application server AS, receiving means for receiving authorization information 12., 15. for said requested streaming session from a controlling entity P-CSCF/PCF, and streaming means, responsive to said received authorization, for performing streaming, 16., 18., between the terminal UE and a streaming server SS;

in terms of an application server such as e.g. a SIP application server, an application server comprises receiving means for receiving a request, 1.-3., for a streaming session from a terminal UE, negotiation means for negotiating, 4.-8., streaming session details with a streaming server SS, and transmission means for informing, 9.-10., a controlling entity P-CSCF/PCF of the negotiation results;

in terms of a streaming server, a streaming server comprises negotiation means for negotiating, 4.-7., streaming session details with an application server AS; and

in terms of a controlling entity such as a P-CSCF/PCF entity, a controlling entity comprises receiving means for receiving, 9.-10., negotiated streaming session details from an application server AS, creation means for creating, 11., authorization information for a requested streaming session, and supplying means for supplying, 14., access nodes of a communication network with the authorization information.

Accordingly, as has been described herein above, the present invention concerns a method for controlling streaming services between a terminal UE and a streaming server SS via a communication network, wherein the communication network comprises at least one application server AS and a controlling entity PCF, CSCF, the method comprising the steps of: requesting 1-3 a streaming session by said terminal at said application server, negotiating 4-8 streaming session details between the application server AS and the streaming server SS, informing 9-10 the controlling entity PCF of the result of negotiating, and creating 11, at said controlling entity PCF, authorization information for the requested streaming session, and supplying 14 access nodes GGSN of the communication network with the authorization information.

While the invention has been described with reference to a preferred embodiment, the description is illustrative of the invention and is not to be construed as limiting the invention. Various modifications and applications may occur to those skilled in the art without departing from the true spirit and scope of the invention as defined by the appended claims.

1. A method for controlling streaming services between a terminal (UE) and a streaming server (SS) via a communication network, wherein the communication network comprises at least one application server (As) and a controlling entity (PCF, CSCF), the method comprising the steps of:
requesting (1-3) a streaming session by said terminal at said application server,
negotiating (4-8) streaming session details between the application server (AS) and the streaming server (SS),
informing (9-10) the controlling entity (PCF) of the result of negotiating, and
creating (11), at said controlling entity (PCF), authorization information for the requested streaming session, and supplying (14) access nodes (GGSN) of the communication network with the authorization information.

2. A method according to claim 1, further comprising a step ofapplying (15) said authorization information at the gateway nodes (GGSN) for the requested streaming session.

3. A method according to claim 1, wherein said requesting comprises including the source and destination addresses and port numbers in the request.

4. A method according to claim 3, wherein said requesting further comprises including quality of service Qos information in the request.

5. A system for controlling streaming services between a terminal (UE) and a streaming server (SS) via a communication network, the system comprising a terminal (UE), a streaming server (SS), and a communication network, wherein the communication network comprises at least one application server (AS) and a controlling entity (PCF, CSCF), the system being configured such that:
said terminal transmits a request (1-3) for a streaming session to said application server, the application server (AS) and the streaming server (SS) negotiate (4-8) streaming session details,
said application server (AS) transmits information (9-10) of the result of negotiating to the controlling entity (PCF), and
said controlling entity (PCF) creates (11) authorization information for the requested streaming session, and supplies (14) access nodes (GGSN) of the communication network with the authorization information.

6. A system according to claim 5, further configured such that said authorization information is applied (15) at the gateway nodes (GGSN) for the requested streaming session.

7. A system according to claim 5, wherein said request comprises the source and destination addresses and port numbers.

8. A system according to claim 7, wherein said request further includes quality of service QoS information.

9. A terminal, comprising
transmission means for transmitting a request (1.) for a streaming session to an application server (AS),
receiving means for receiving authorization information (12., 15.) for said requested streaming session from a controlling entity (P-CSCF/PCF), and
streaming means, responsive to said received authorization, for performing streaming (16., 18.) between the terminal (UE) and a streaming server (SS).

10. An application server, comprising
receiving means for receiving a request (1.-3.) for a streaming session from a terminal (UE),
negotiation means for negotiating (4.-8.) streaming session details with a streaming server (SS),
transmission means for informing (9.-10.) a controlling entity (P-CSCF/PCF) of the negotiation results.

11. A streaming server, comprising
negotiation means for negotiating (4.-7.) streaming session details with an application server (AS).

12. A controlling entity, comprising
receiving means for receiving (9.-10.) negotiated streaming session details from an application server (AS),
creation means for creating (11.) authorization information for a requested streaming session, and
supplying means for supplying (14.) access nodes of a communication network with the authorization information.
